(19) United States
(12) Patent Application Publication
(10) Pub. No.: US 2009/0038175 A1
(43) Pub. Date: Feb. 12, 2009

(54) Household appliance for the care of items of laundry,in particular a clothes dryer

(75) Inventor: Andreas Ziemann, Potsdam (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch Siemens Hausgerate GmbH, Munchen (DE)

(21) Appl. No.: 11/920,889

(22) PCT Filed: Feb. 22, 2006
(86) PCT No.: PCT/EP2006/060163

§ 371 Date: Nov. 19, 2007

(30) Foreign Application Priority Data
May 20, 2005 (DE) 10 2005 023 442.9

(51) Int. Cl. F26B 25/06

(52) U.S. Cl. 34/218

(57) ABSTRACT

The invention relates to a household appliance for the care of items of laundry, in particular, a clothes dryer, with an air-guiding device arranged in the region of the rear side of the household appliance, the air-guiding device having a flow duct which has two opposite open end regions. A fan device is arranged on one end region and a fan cover is positioned in such a manner that at least the fan device is covered by the fan cover and at least the fan device is covered in a double-walled manner in the region facing away from the household appliance.

The invention relates to a household appliance for the care of items of laundry, with an air-guiding device arranged in the region of the rear side of the household appliance, with the air-guiding device having a flow duct, which has two opposite open end regions, with a fan device being arranged on one end region and a covering being positioned in such a manner that at least the fan device is covered by the covering.

During operation of this known clothes dryer relatively high energy losses occur, particularly at metal parts of the clothes dryer. This frequently increases the energy consumption of such household clothes dryers considerably. Also air-guiding noise is emitted over large metal surfaces of the household clothes dryer, causing a considerable noise output. Also the known household clothes dryers have the disadvantage that drying times are frequently relatively long, which is also due to inadequate air guiding.

The object of the present invention is therefore to create a household appliance for the care of items of laundry, having a reduced energy consumption and also relatively low noise output during operation. It is an object of the present invention in particular to create a clothes dryer, which can also guarantee a reduction in drying time as well as low energy consumption and quiet operation.

This object is achieved by a household appliance for the care of items of laundry, having the features of claim 1.

An inventive household appliance for the care of items of laundry has an air-guiding device arranged in the region of the rear side of the household appliance. The air-guiding device has a flow duct, which has two opposite open end regions, with a fan device being arranged on one end region and a covering being positioned in such a manner that at least the fan device is covered by the covering. One important concept of the invention is that at least the fan device is covered in a double-walled manner in the region facing away from the household appliance. Such double-walled covering of the fan device on the outside of the fan device allows a significantly improved insulation effect to be achieved. The energy consumption of the inventive household appliance can also be reduced as a result and in particular if the inventive household appliance is embodied as a clothes dryer it is also possible to reduce the drying time for items of laundry to be cared for in the clothes dryer.

The double-walled covering of the fan device is advantageously embodied by the covering and an additional separate cover, arranged between the fan device and the covering. The fan device is thus covered by two separate elements in the region facing away from the household appliance, with these two elements being guided within one another to cover the fan device, thereby also allowing an extremely space-saving embodiment to be achieved.

The additional separate cover is preferably made of plastic. This allows the number of metal surfaces in the household appliance to be reduced and the separate cover can be produced relatively easily.

The air-guiding device preferably has a closed flow duct with open end regions, with the closed flow duct preferably being embodied in two parts and being embodied by a wall region of the rear side of the household appliance facing the outside of the household appliance and an element with a U-shaped cross-section arranged on this wall region. This allows very effective and efficient air guidance between the fan device and a heating device, which can be connected to an open end region of the air-guiding device. A flow duct closed in this manner also allows the energy consumption of the household appliance to be reduced further and the drying time of items of laundry to be cared for in the household appliance can also be decreased further.

The fan device and heating device are advantageously connected to the air-guiding device, it being possible to connect the heating device to the first open end region and the fan device to the second open end region of the closed flow duct.

The fan device advantageously has a fan impeller, with the fan impeller being arranged in a housing, said housing having an opening, which opens into the second open end region of the closed flow duct. This allows the guiding of air from the fan device, in particular from the fan impeller by way of the closed flow duct to the heating device and from this into a drum of the inventive household appliance, in which the items of laundry to be cared for are contained, to be optimized.

Further advantageous refinements of the invention are set out in the subclaims, which can be combined with each other in any manner according to the invention.

A preferred exemplary embodiment of the invention is described in more detail below with reference to the schematic drawings, in which:

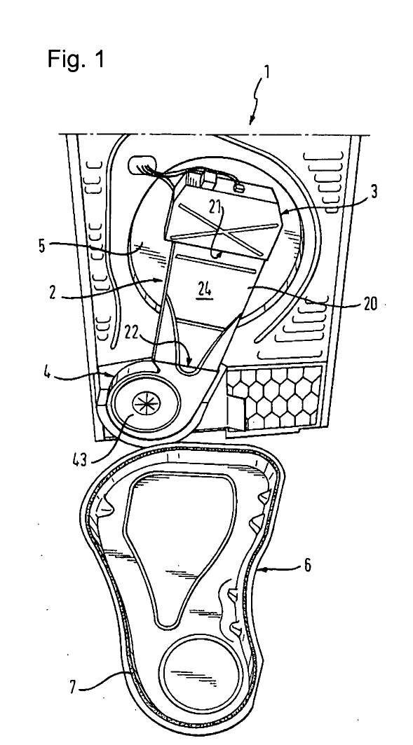

FIG. 1 shows a perspective illustration of a rear view of an inventive household appliance;

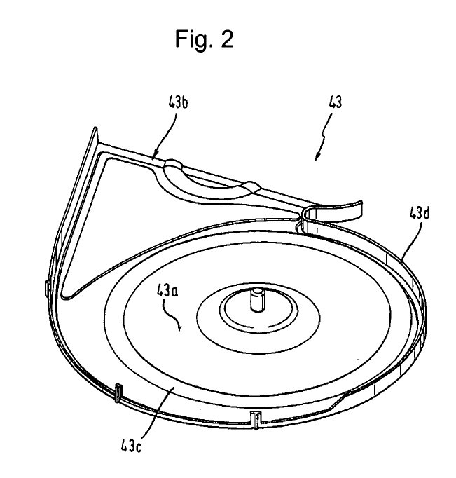

FIG. 2 shows a perspective illustration of an additional separate cover for the inventive household appliance; and

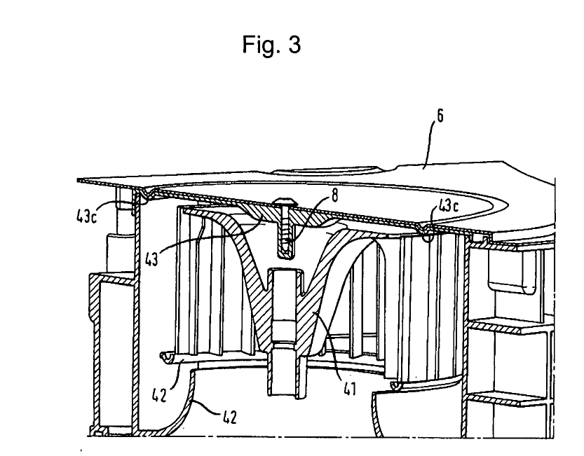

FIG. 3 shows a perspective sectional illustration of the inventive household appliance.

In FIGS. 1 to 3 identical elements or those with an identical function are assigned identical reference characters.

In the perspective illustration according to FIG. 1 an inventive household appliance for the care of items of laundry is embodied as a clothes dryer 1, with FIG. 1 showing a view of the clothes dryer 1 from behind. In the exemplary embodiment the clothes dryer 1 has an air-guiding device 2, which comprises a flow duct 20, oriented in an essentially vertical manner in the exemplary embodiment. In the exemplary embodiment the flow duct 20 is embodied as closed in a cross-sectional illustration (cross-sectional line in a horizontal direction with a sectional plane that is oriented at right angles to the plane of the figure). The flow duct 20 is hereby formed by an element 24 with a U-shaped cross-section, embodied in the exemplary embodiment as a sheet metal component, and a wall region 5 of the rear side of the clothes dryer 1. The opening of the U-shape of the element 24 formed with a U-shaped cross-section here faces the wall region 5 and is connected permanently to said wall region 5 by mechanical means. The flow duct 20 thus configured has open end regions 21 and 22, which are embodied opposite each other and which are oriented in such a manner that a heating device 3 is connected to the first open end region 21 and a fan device 4 is connected to the second open end region 22.

In the exemplary embodiment the fan device 4 has a fan impeller 41 (not shown), which is enclosed by a housing 42 (not shown). The fan device 4 and in particular the fan impeller 41 are covered in the inventive manner in the region facing away from the clothes dryer 1 by an additional separate cover 43. The region of the fan device 4 facing away from the wall region 5 is referred to here as the region facing away from the clothes dryer 1. At least the fan device 4, in particular the fan impeller 41, is also covered with a further covering 6. In the exemplary embodiment shown according to FIG. 1 this covering 6 is removed from the rear side or in particular from the wall region 5 for purposes of clarity. In the assembled state this covering 6 is arranged on the rear side, in particular on the wall region 5. In the exemplary embodiment this covering 6 is embodied in such a manner that it covers the fan device 4 and therefore also the additional separate cover 43, as well as the air-guiding device 2, in particular the closed flow duct 20, as well as the heating device 3. Therefore a double-walled covering of the fan device 4 is achieved in the region of said fan device 4 and in particular in the region of the fan impeller 41.

As also shown in the illustration in FIG. 1, a seal 7 is arranged, in particular adhered, in a peripheral manner around the edge region of the covering 6, sealing off the region between the covering 6 and the wall region 5.

FIG. 2 shows a perspective illustration of the additional separate cover 43. The inside 43a of this cover 43 facing the fan impeller 41 can be seen here. The cover 43 here has an opening 43b facing the second open end region 22 of the closed flow duct 20, said opening 43b corresponding essentially to the width of the second open end region 22. An annular bead 43c is also embodied in the region opposite the fan impeller 41. In the exemplary embodiment the additional separate cover 43 is made of plastic.

FIG. 3 shows a perspective sectional illustration of the inventive clothes dryer 1 in the region of the fan device 4. It can be seen from FIG. 3 that the additional separate cover 43 is arranged between the fan impeller 41 and the housing 42 of the fan device 4 and the covering 6. In the exemplary embodiment shown the additional separate cover 43 is connected to the covering 6 by way of a screw connection 8. It can also be seen that the covering 6 also has an annular peripheral bead, which engages with a close fit in the annular peripheral bead 43c of the cover 43. The edge zone 43d of the cover 43 shown in FIG. 2 is also arranged so that it is adjacent to housing components of the housing 42. In the exemplary embodiment shown the covering 6 is directly adjacent to the additional separate cover 43 in the region of the fan device 4. This can improve the insulation effect in particular to a significant degree. The air flow from the fan device 4 by way of the closed flow duct 20 can also be guided with very little noise by way of the heating device 3 into a drum (not shown) of the clothes dryer in which the items of laundry to be cared for are contained.

1-7. (canceled)

8. An appliance for handling laundry items, in particular a clothes dryer, the appliance comprising:
a.) means forming a laundry item handling area in which laundry items to be handled are received;
b.) a housing in which the means forming a laundry handling area is located, the housing including a back side wall forming at least a portion of a back side of the appliance;
c.) an air conveying duct assembly mounted adjacent the back side wall, the air conveying duct assembly having a first open end area communicated with a heating device and a second open end area communicated with a fan device having a fan impeller disposed in a fan housing;
d.) a fan housing cover that covers the fan housing of the fan device; and
e.) an outer cover that covers the fan housing of the fan device and the air conveying duct assembly, the fan housing cover being disposed intermediate the fan device and the outer cover.

9. The appliance as claimed in claim 8, wherein the fan housing cover is made of plastic.

10. The appliance as claimed in claim 8, wherein the air conveying duct assembly is closed.

11. The appliance as claimed in claim 10, wherein the air conveying duct assembly is delimited by the back side wall and an element having a U-shaped cross-section formed on the back side wall.

12. The appliance as claimed in claim 8, wherein the first open end area and the second open of the air conveying duct assembly are configured opposite to one another, with the first open end area being arranged in a substantially vertical manner above the second open end area.
